(19) United States
(12) Patent Application Publication
(10) Pub. No.: US 2009/0219584 A1
(43) Pub. Date: Sep. 3, 2009

(54) METHOD AND SYSTEM FOR CONTROLLING LED ILLUMINATION IN AN IMAGING DEVICE

(75) Inventor: Thomas INGENDOH, Wuppertal (DE)

Correspondence Address: MCDERMOTT WILL & EMERY LLP, 600 13TH STREET, N.W., WASHINGTON, DC, 20005-3096, US

(73) Assignee: BOWE BELL & HOWELL SCANNERS L.L.C.

(21) Appl. No.: 12/039,101

(22) Filed: Feb. 28, 2008

(51) Int. Cl. H04N 1/04

(52) U.S. Cl. 358/475

(57) ABSTRACT

The present subject matter relates to methods and systems for scanning documents, wherein the on and off times of an LED light source are controlled proportionally to the line sync rate of the scanner, allowing the gain value applied to an image sensor output to be fixed, and thereby eliminating the need to recalibrate the scanner each time the line sync rate is changed. This allows the LED light source to provide appropriate illumination for imaging devices, without saturation of the A/D and without color shift when scanning at different line sync rates. The LEDs are turned on during each line scan period for a set, predetermined amount of time, and then are turned off for the remaining duration of the line scan period, regardless of the line sync rate.

### TECHNICAL FIELD

The exemplary teachings herein pertain to methods and systems for scanning documents, and in particular, to an illumination system for an imaging device, such as a scanner, facsimile, digital copying machine or the like, and a method for controlling the illumination of an LED light source. Specifically, the present disclosure relates to methods and systems for LED illumination characterized by a fixed LED on-time gated by variable line sync rates of a scanner.

### BACKGROUND

It is well known in the art of imaging equipment to use a light source to provide illumination for an image capture or sensing device so that the image capture or sensing device can properly sense the reflected light from an image on a document. Signals outputted from the image capture or sensing device are suitably processed to create a digital image corresponding to the image on the document being scanned.

Two different types of image capture or sensing devices are typically found in imaging equipment. The first type of image capture or sensing device is a camera or video camera with a charge-coupled device (CCD). Light from a light source is reflected off a document being scanned, and directed by mirrors to the camera. The reflected light from the scanned image is projected by the camera lens onto the capacitor array of the CCD. Each capacitor accumulates an electric charge proportional to the light intensity at that location. These electrical charges are converted into a varying voltage which is ultimately digitized and stored as the scanned image. Cameras with CCDs are typically found in mid to high end scanners and can produce high image quality. Illumination in such CCD scanners is typically provided by a tube light source, such as a fluorescent tube or cold-cathode tube.

The second type of image capture or sensing device is known as a Contact Image Sensor (CIS). CIS modules are typically found in lower end scanners. A CIS typically consists of a linear array of detectors, covered by a focusing lens and flanked by red, green and blue LEDs for illumination. CIS modules typically produce lower image quality compared to CCD devices.

The signals outputted from either type of image capture or sensing device are typically processed by sensor signal processing circuitry which amplifies the signals, converts the signals from analog to digital, and then sends the signals to an image processor. FIGS. 1 and 2, taken from U.S. Pat. No. 7,308,375, issued to Jensen et al. on Dec. 11, 2007 (the entire disclosure of which is herein incorporated by reference), illustrate by way of example the processing of the signals outputted from a CIS. As can been seen in FIG. 1, the output signals from a sensor array 129 in a scanner 100 are sent to a sensor signal processing interface 116, which processes the signals and sends them via an interface 109 to an image processor 103.

The sensor signal processing circuitry 116a of the sensor signal processing interface 116 is illustrated in FIG. 2. As shown therein, the signals outputted from the sensor (sensor values) are first applied to a programmable gain amplifier 156, which applies an analog offset 159 and an analog gain 163 to the sensor values. The sensor values are then applied to an analog-to-digital (A/D) converter. The digital sensor values are applied to a digital offset subtractor 169 and a digital amplifier 179, which apply a digital offset and a digital gain, respectively, to the digital sensor values. The digital sensor values are then applied to a nonlinear converter 183 and sent to the processor 103.

The appropriate gain values to be applied to the sensor values are pre-calibrated and stored in a table, e.g., digital offset/gain table 176. The specific gain value to be applied from the table is determined based upon the line sync rate of the scanner. When the line sync rate of a scanner changes, the scanner must be re-calibrated, and the appropriate gain value to be applied to the sensor values must be determined from the table stored in memory. Such re-calibration of a CCD scanner with a fixed amount of LED illumination at the desired high speeds in mid to high end scanners is time consuming. The calibration process becomes long and user unfriendly when there are, for example, over three to five line sync points to calibrate.

A typical scanner will use different line sync rates for one of two reasons. First, a scanner may use a slower line sync rate in color mode or in high dots-per-inch (DPI) mode. For example, because of typical image processing bottleneck downstream of the camera, the scanner may slow down camera speed in color mode by using a slower line sync rate. The scanner may use a higher line sync rate in Bitonal or GrayScale modes (1 byte per pixel) then in Color mode (3 bytes per pixel).

Second, a scanner will use a different line sync rate according to the transport speed, i.e., the line sync rate will change when the scanner changes from a normal (high) transport speed mode to a reduced transport speed mode. The scanner may reduce transport speed, for example, to reduce paper handling stress in a fragile document mode. The scanner may also reduce transport speed when an associated computer system experiences a processing bottleneck or delay in communication with the scanner. This could occur, for example, when the computer system is running slow due to having multiple programs running simultaneously, thus triggering the scanner to slow transport speed, resulting in a slower line sync rate.

In general, line sync rate is typically determined based upon operator selected scan parameters. The scanner will operate at the appropriate line sync rate for the selected mode of operation. However, as discussed above, the scanner may slow transport speed and thus the line sync rate, due to image processing bottlenecks, delayed or slowed computer system communications, or other computer related issues.

Line sync along with paper speed translates in scanner vertical resolution. The line sync rate and transport speed are typically set as fast as possible to maximize the scanner throughput. However, the faster the scanner throughput, the greater the intensity of the lighting or the illumination must be for the camera CCD to adequately capture or sense the image being scanned. At higher speeds, there is a recognized problem in obtaining a sufficient amount of light, and/or obtaining smooth luminance distribution with respect to an LED light source. As such, the use of LED illumination has for the most part been limited to lower end CIS scanners, and has not been suitable for mid to high end CCD scanners.

Problems using an LED light source for an imaging device typically occur when the scan rate changes. A lower line sync rate would result in saturation of the A/D connected to each CCD element if the LEDs were left on at full intensity for the full scan period. A known method used to address this problem is to vary the current into the LED light source to lower or dim the light level for slower scan rates. In early color scanners using red, green and blue LED rows for illumination, the current variation method was used successfully to vary the LED intensity. This method, however, only worked for monochromatic LEDs, due to color shift or undesirable spectral drift produced when varying the current on white LEDs. The introduction of white LEDs eliminated the need for rows of red, green and blue LEDs, however, the intensity of the illumination still could not be changed without color shift.

Another known method of dimming an LED light source is by pulse width modulation (PWM). PWM works by changing the duty cycle of the LEDs, i.e., the amount of time the LEDs are on (pulse on time duration) within a fixed signal period. In PWM, the duty cycle is changed by varying or changing the pulse on time duration of the LEDs within a given signal period. However, PWM suffers from the above identified disadvantages in that varying the LED pulse on time duration results in luminance issues, as well as the need to recalibrate gain.

As such, PWM is not an option for use in the disclosed method and system because a variable amount of illumination on time, which results from PWM, would require gain adjustments in the image sensor in order to compensate for the illumination change. Gain adjustments result in changes in the signal to noise ratio, which impacts image quality, and requires calibration for each of the illumination levels that are selected. Both of these disadvantages are avoided by the disclosed method and system of controlling LED illumination, which does not use PWM, as the LED duty cycle for a given signal period is not changed, i.e., the pulse on time duration is not changed or varied within a given signal period. Further, in the disclosed method and system, the pulse on time duration is a set, predetermined duration, regardless of the signal period, as discussed in detail below.

One recent attempt to use LED illumination in a CCD scanner is disclosed in U.S. Pat. No. 7,315,405 B2 issued to Tsuboi on Jan. 1, 2008, the entire disclosure of which is herein incorporated by reference. FIG. 3, taken from the Tsuboi patent, illustrates the combined use of an LED array and a cold-cathode tube as a CCD scanner light source. However, the LED array is not provided to be used as the sole light source, and the cold-cathode tube is required to provide proper lighting when using the CCD scanner of the Tsuboi patent.

Accordingly, to address the above stated issues, a method and system for LED illumination in scanners, and especially mid to high end CCD scanners, is needed to provide appropriate illumination for varying line sync rates, without color shift or saturation, and without the need to re-calibrate. The exemplary teachings herein fulfill such a need. It is desired that the methods and systems for providing the above benefits be applicable to any instances or applications wherein a light source for a CCD or other light sensor is required.

### SUMMARY

The exemplary technique(s), system(s) and method(s) presented herein relate to an LED illumination method and system for imaging equipment, such as mid to high end CCD scanners. The exemplary method and system include the use and control of an LED light source as the sole illumination means. The LED light source provides controlled illumination for varying line sync rates. The on and off time of the LEDs is controlled proportionally to the line sync rate during the scanning process to prevent illumination saturation of the CCD. The LEDs are driven with a fixed current to prevent color shift. Further, the A/D gain is fixed, eliminating the need to re-calibrate the scanner for different line sync rates.

Accordingly, an exemplary scanner has a camera with a CCD, and an LED light source to provide illumination for the camera. Scanners including an imaging system and illumination system are a component in document scanners, facsimile machines, digital copying machines, plus mail sorting and inserting machines. Each of these systems has the ability to vary the document transport speed and hence can benefit from the disclosed exemplary technique(s).

The exemplary document scanner further includes control circuitry for controlling the on and off times of the LED light source during the scanning process. The control circuitry turns the LEDs on and off during each line sync period, such that the LEDs are on for a portion of the line sync period and are then turned off for the remaining portion of the line sync period. The on time of the LEDs is preferably fixed such that the LEDs are on for the same amount of time during each line sync period, regardless of the line sync rate, and are then turned off for the duration of the line sync period. Thus, at the fastest line sync rate (shortest time period), the LEDs are on for a relatively high percentage of the time during the line sync period. As the line sync rate is slowed, the percentage of time during which the LEDs are on decreases, and the percentage of time that the LEDs are off increases. The net result is that the total illumination integrated over the slower sync period is lower due to the fixed on time and the variable off time of the LEDs.

Since the LEDs are driven with a fixed current, the illumination intensity of the LEDs remains constant over a wide range of line sync rates. As a result, the CCD output is constant over a wide range of line sync rates. The CCD output signals are processed by signal processing circuitry. The signal processing circuitry includes an amplifier which applies a set or fixed gain value to the CCD output signals. This gain value is constant, i.e., it does not change according to a gain table, such that the scanner does not need to be re-calibrated when the line sync rate changes.

Additional objects, advantages and novel features will be set forth in part in the description which follows, and in part will become apparent to those skilled in the art upon examination of the following and the accompanying drawings or may be learned by production or operation of the examples.

### BRIEF DESCRIPTION OF THE DRAWINGS

The drawing figures depict one or more implementations in accord with the present teachings, by way of example only, not by way of limitation. In the drawing figures, like reference numerals refer to the same or similar elements.

FIG. 1 is a block diagram of a prior art CIS scanner;

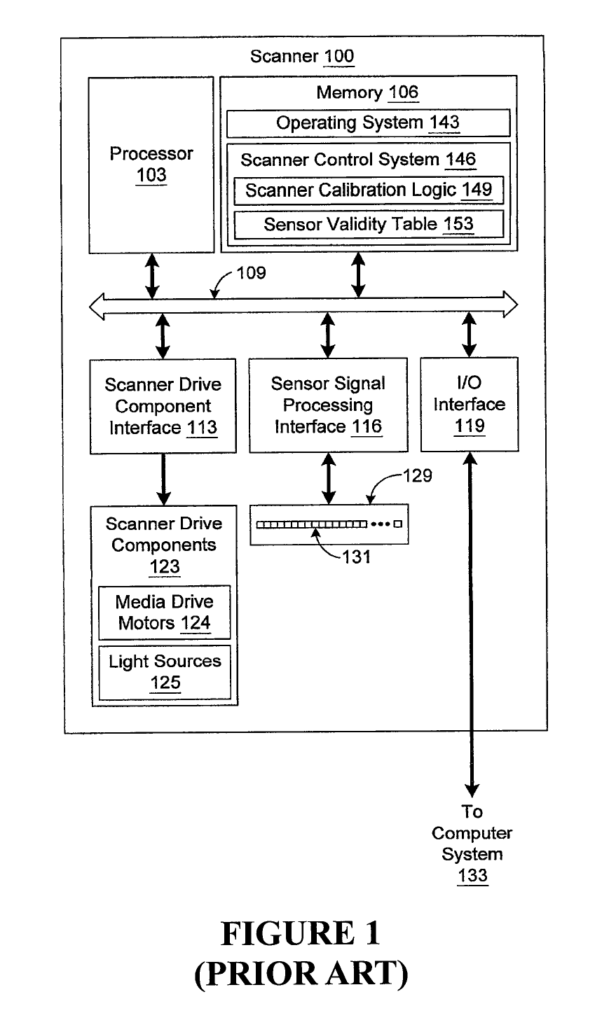

FIG. 2 is a functional block diagram of prior art sensor signal processing circuitry of the CIS scanner of FIG. 1;

FIG. 3 is an illustration of a prior art light source for a CCD scanner;

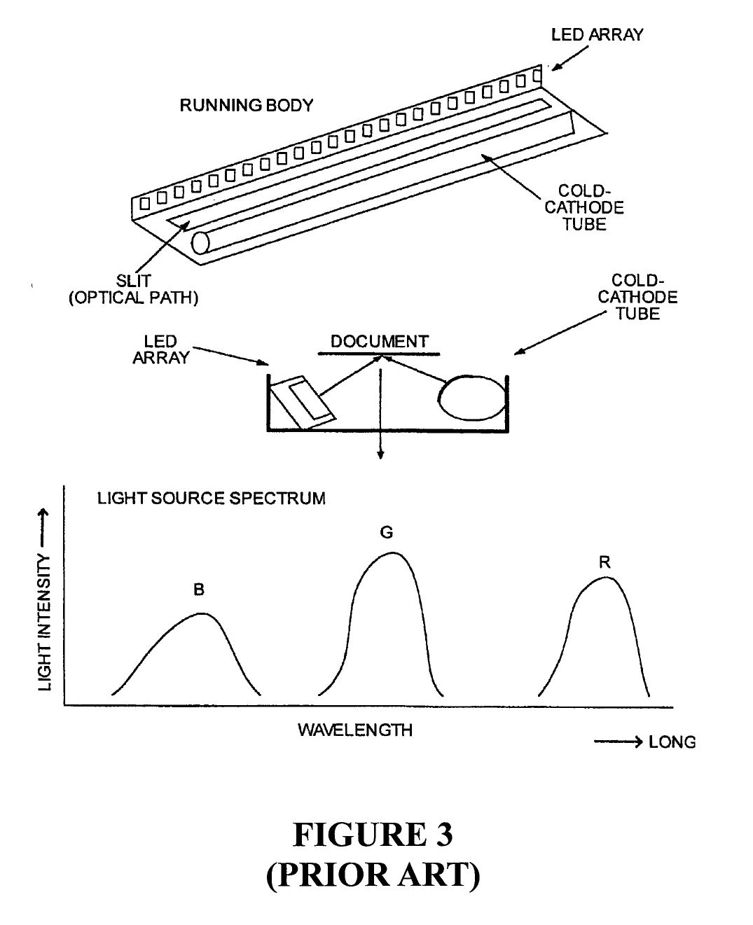

FIG. 4 is an exemplary side view depiction of a CCD scanner utilizing the method and system of the present disclosure;

FIG. 5 is an exemplary perspective view depiction of the light source and camera of the CCD scanner of FIG. 4;

FIG. 6 is a graph showing exemplary on and off times of the light source for various line sync rates; and

FIG. 7 is a flow chart depicting the exemplary method and system of the present disclosure.

### DETAILED DESCRIPTION

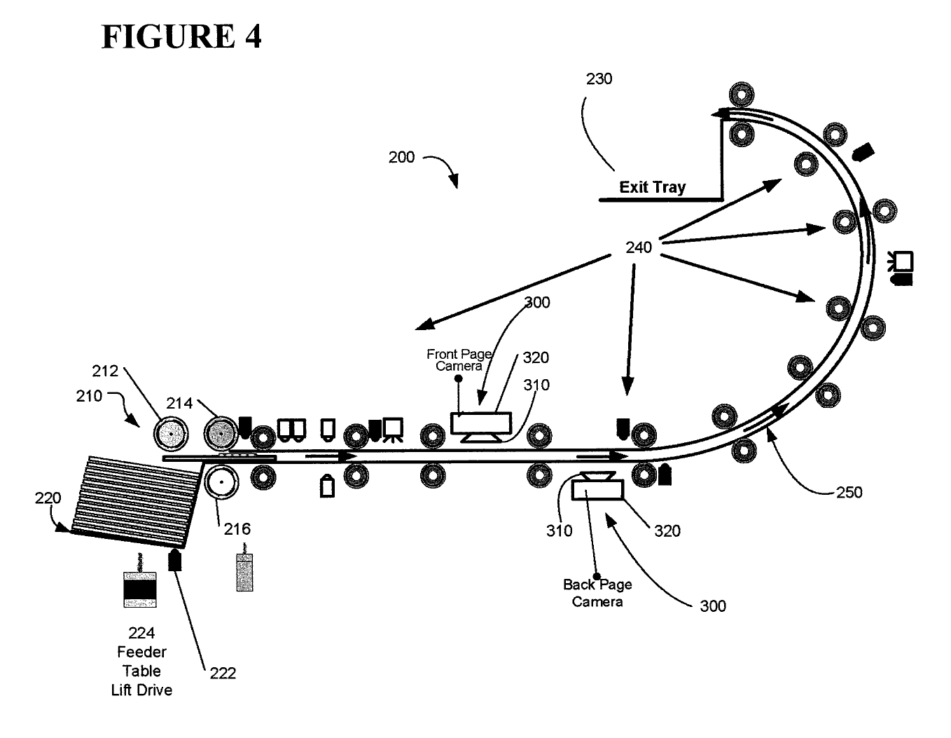

The following description refers to numerous specific details which are set forth by way of examples to provide a thorough understanding of the relevant teachings. It should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings. It will be appreciated by those versed in the art that the exemplary teachings described herein enable the controlled LED illumination for an image scanning device. The description now proceeds with a discussion of FIGS. 4-7, which depict by way of example the following: a side view depiction of an exemplary CCD scanner device, a perspective view depiction of an exemplary LED light source and camera of the CCD scanner device, a graph showing exemplary on and off times of the LED light source for various line sync rates, and a flow chart of the method and system for controlled LED illumination, respectively.

The exemplary scanner device and its transport system 200 of FIG. 4 are comprised of various functional components for facilitating and/or enabling its multitude of operating features. Entry into the transport system 200 of the scanner, wherein the various scanning functions are performed upon the document, is facilitated by usage of a document feeder or feed roller system 210 and a document feeder tray table 220 for supporting multiple pages of a document or stack of documents underneath the document feeder 210. At the other end of the transport system 200 is an exit tray 230 for storing accumulated documents upon full transport through the scanner transport system 200. In between the feed roller system 210 and the exit tray 230 are a plurality of transport rollers 240 which transport the documents along a transport path 250 through the scanner device.

The feed roller system 210 comprises a pick roller 212, a feed roller 214, and a separator or retard roller 216, which are driven by any suitable drive system. The feed roller system 210 delivers a document from the feeder tray 220 to the main transport rollers 240, which are driven by any suitable drive system. The pick roller 212 pushes the top document from the feeder tray 220 into the scanner's entry/separation nip formed by the feed roller 214 and the separator/retard roller 216. The feed roller 214 then pushes the top document into the transport rollers 240, while the separator/retard roller 216 pushes any documents which may be under the top document backward or away from the nip to avoid feeding multiple documents into the transport path 250 at the same time.

When a stack of one or more documents is placed into the document feeder table/tray 220, the paper in feeder sensor (PIF) 222 detects the presence of the document, and activates the feeder table lift/drive 224 which in turn lifts the stack in the direction of document feeder 210 for input into the transport path 250. Upon receipt of a scan command, the document feeder 210 of the scanner moves the top page of the stack of documents, one at a time sequentially from the stack, directing the top page downstream through the transport path 250 via main transport rollers 240. The rollers 240 are linked together via a transport belt, which also enables the pages of the stack of documents to be gripped for advancement down the transport path 250 appropriately, until they eventually reach the exit tray 230.

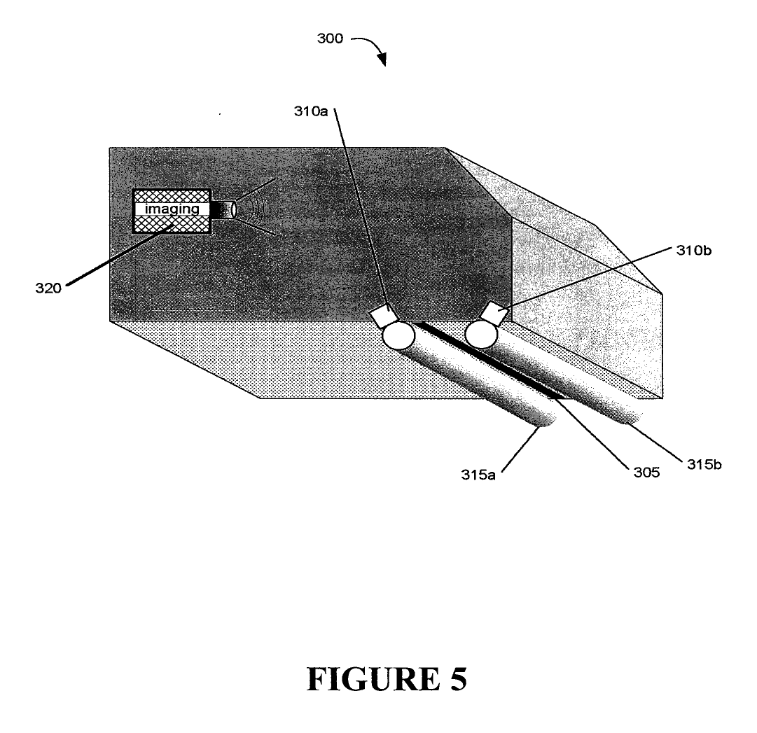

Positioned along the transport path 250 is at least one image capture or sensing device 300. In the exemplary scanner of FIG. 4, the image capture or sensing device includes a front page CCD camera and a back page CCD camera, generally illustrated by reference number 320. Cameras 320 are preferably video cameras as is known in the art of scanning. Each of the cameras 320 has an associated LED light source, generally illustrated by reference number 310. Each LED light source 310 preferably comprises a pair of high brightness, white LED arrays, such as the LED arrays 310a and 310b depicted in FIG. 5. Suitable high brightness, white LEDs are Indium Gallium Nitride LEDs. It should be understood however that any suitable LEDs can be used so long as they provide a high enough brightness to permit the desired image capture at the desired speeds.

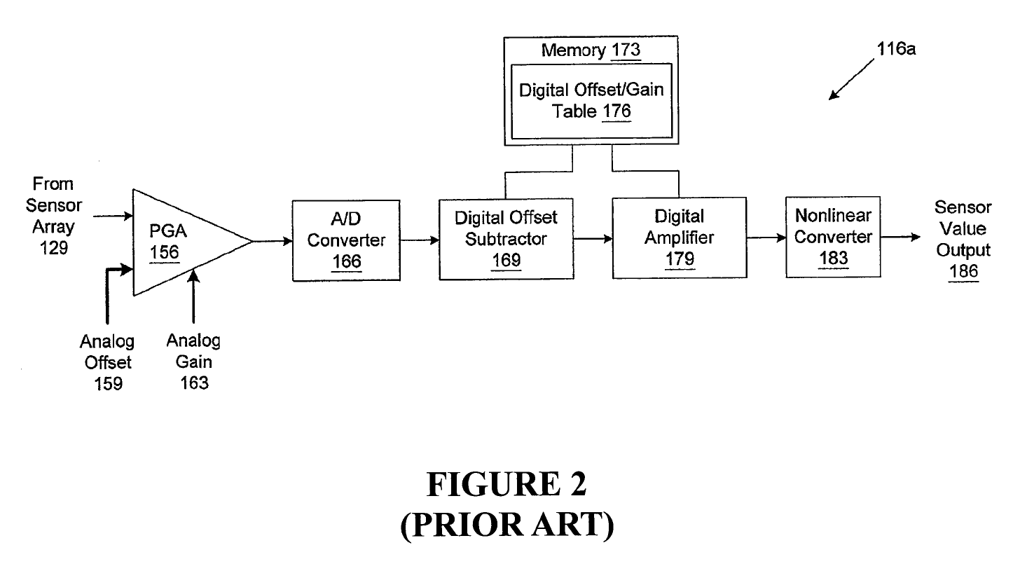

Referring now to FIG. 5, the LED arrays 310a and 310b are arranged along both sides of an aperture 305, one on each side. Light from the LED arrays 310a and 310b is directed through respective cylindrical lens 315a and 315b to the document being scanned. The light reflected off the document being scanned and through the aperture is directed by mirrors to the lens of the CCD camera 320, and then onto the CCD. As discussed with respect to FIG. 2, the output signals from the camera's CCD are processed by sensor signal processing circuitry. This sensor signal processing circuitry includes an amplifier for applying a gain value to the output signals. However, unlike the prior art wherein the gain value is table driven and varies according to the scanner's line sync rate, the exemplary scanner of the present disclosure sets or fixes this gain value, such that the amplifier applies a constant gain value regardless of the scanner's line sync rate.

Accordingly, the time period for each line scan, i.e., for the processing of that portion or area of the document appearing through the aperture, is determined by the line sync rate. The camera will process each line scan for the scan period of the line sync rate, before starting the process over for the next line scan. For example, at a line sync rate of 200 μs, the camera will take 200 μs to process the line being scanned. After the 200 μs, the camera will then process the next line scan for a period of 200 μs. As a document is being scanned, this process is repeated over and over a number of time periods based upon the line sync rate, until the entire document has been scanned.

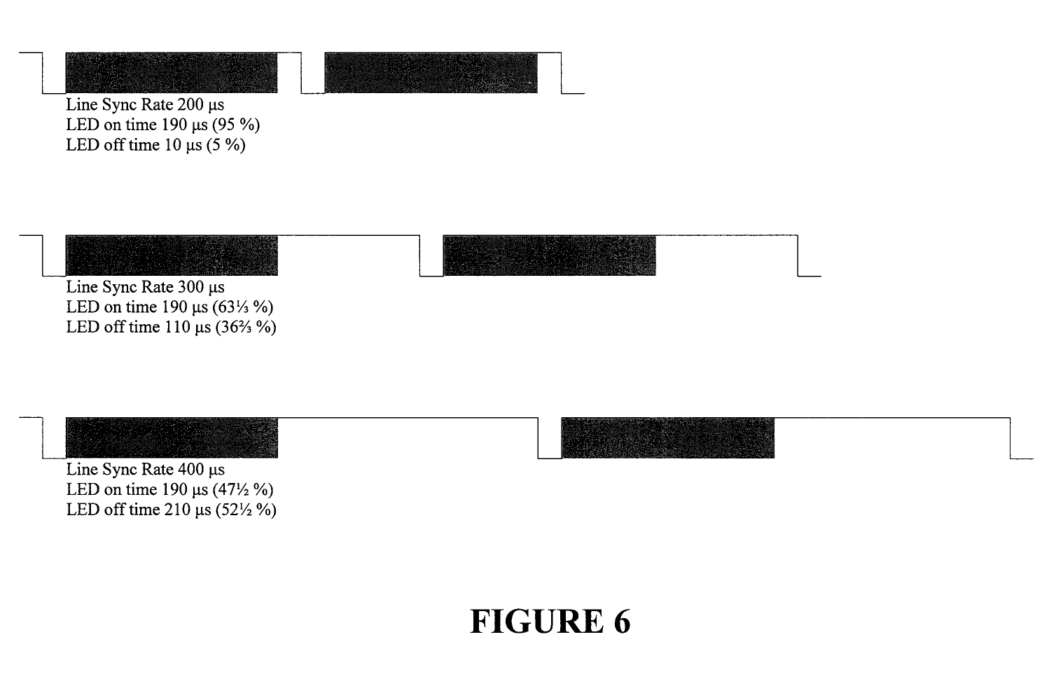

In the method and system disclosed herein, the LEDs are controlled by turning the LEDs on and off during each of the line scan periods. The LEDs are preferably turned on at the start of a line scan period, and are then turned off after a predetermined amount of time for the remainder of the line scan period. For example, for a line sync rate of 200 μs, the LEDs will turn on at the start of the line scan period, and will turn off after a predetermined amount of time, such as 190 μs. As such, the LEDs will be turned off for a period of time during the line scan period, 10 μs in this example. The period of time that the LEDs are turned off during each line scan period will vary based upon the line sync rate, as discussed in more detail below with respect to FIG. 6.

While the LEDs are preferably turned on at the start of the line scan period, it should be understood, however, that the LEDs could be turned on after an initial off period during the line scan period. Thus, in the example above, the LEDs could be off at the start of the line scan period for an initial period of time, e.g., 5 μs, and then turned on for the predetermined amount of time, e.g., 190 μs, and then turned off for the remaining 5 μs of the line scan period. In general, the LEDs can be controllably turned on and off at any time during a line scan period, even intermittently if desired, so long as the LEDs are on for a total time period equal to the predetermined amount of time.

In the preferred embodiment of the method and system disclosed herein, the predetermined LED on time is set consistent with the highest sync rate and with sufficient illumination intensity to produce a good signal to noise ratio in the A/D by setting the A/D gain relatively low. Thereafter, when the line sync rate is slowed (longer line scan period), the LEDs will be turned on for this same set, predetermined on time, and then will be turned off for the remaining line scan period. It will be appreciated then that at slower line sync rates, the LEDs will be on for the same predetermined amount of time, but for a lower percentage of time during the line scan period, and off for a longer amount of time and for a higher percentage of time during the line scan period, than at a faster line sync rate. The LED current and intensity will remain constant or unchanged, regardless of the line sync rate. This prevents saturation of the A/D, as well as color shifting when scanning at different line sync rates.

An illustration of the above described controlling of the on and off times of the LEDs proportional to line sync rate is provided by way of example in the graph of FIG. 6, where successive line scan periods are illustrated for various line sync rates. In the top illustration in FIG. 6, the line sync rate is illustrated, for example, as being 200 μs. The on time for the LEDs during this 200 μs line scan period is illustrated by way of gray shading. Accordingly, as can be seen in this example, the LED on time has been set to a predetermined duration of 190 μs. As such, the LEDs will be on for 95% of the line scan period, and will then be turned off for the remaining 5% of the line scan period. Thus, at the start of each line scan period of 200 μs, the LEDs will be turned on and will remain on for the set, predetermined duration, i.e., 190 μs in this example. The LEDs will then be turned off for the remaining duration of the line scan period, i.e., 10 μs in this example.

In the middle illustration in FIG. 6, the line sync rate is illustrated as having been slowed, for example, to 300 μs. Again, the on time for the LEDs during this 300 μs line scan period is illustrated by way of gray shading. Accordingly, as can be seen in this example, the LEDs are turned on at the start of the line scan period of 300 μs, and remain on for the set, predetermined duration, i.e., 190 μs in this example. The LEDs will then be turned off for the remaining duration of the line scan period, i.e., 110 μs in this example. As such, the LEDs will be on for 63⅓% of the line scan period, and will then be turned off for the remaining 36⅔% of the line scan period.

In the bottom illustration in FIG. 6, the line sync rate is illustrated as having again been slowed, for example, to 400 μs. Again, the on time for the LEDs during this 400 μs line scan period is illustrated by way of gray shading. Accordingly, as can be seen in this example, the LEDs are turned on at the start of the line scan period of 400 μs, and remain on for the set, predetermined duration, i.e., 190 μs in this example. The LEDs will then be turned off for the remaining duration of the line scan period, i.e., 210 μs in this example. As such, the LEDs will be on for 47½% of the line scan period, and will then be turned off for the remaining 52½% of the line scan period.

In general, it should be understood that the LEDs will be turned on for a fixed amount of time during each line scan period, preferably but not necessarily at the start of the line scan period, and will then be turned off for the remaining amount of time in each line scan period. The amount of time that the LEDs are off during each line scan period will vary depending upon the line scan rate. Again, the line sync rate typically changes based upon scan speed, color vs. black and white scanning, other selected scan parameters, processing power, processing bottlenecks, slowed computer system operation, and other factors known in the art of document scanning. As a result, the scanner transport speed in the exemplary scanner can be automatically changed to account for processing bottlenecks or other operational issues, between scans or during a scan, without causing image distortion or non-optimal illumination intensity. In the disclosed method and system, the scanning process can automatically adjust illumination or on/off timing of the LEDs depending on the scanner's transport speed or line sync rate, even if changed during a scan.

Controlling the on and off times of the LEDs as described above prevents saturation of the A/D, and allows the A/D gain to be set as a constant, thus eliminating the need to recalibrate the scanner for different line sync rates. Further, no color shift will occur with this configuration due to the fixed LED current and intensity.

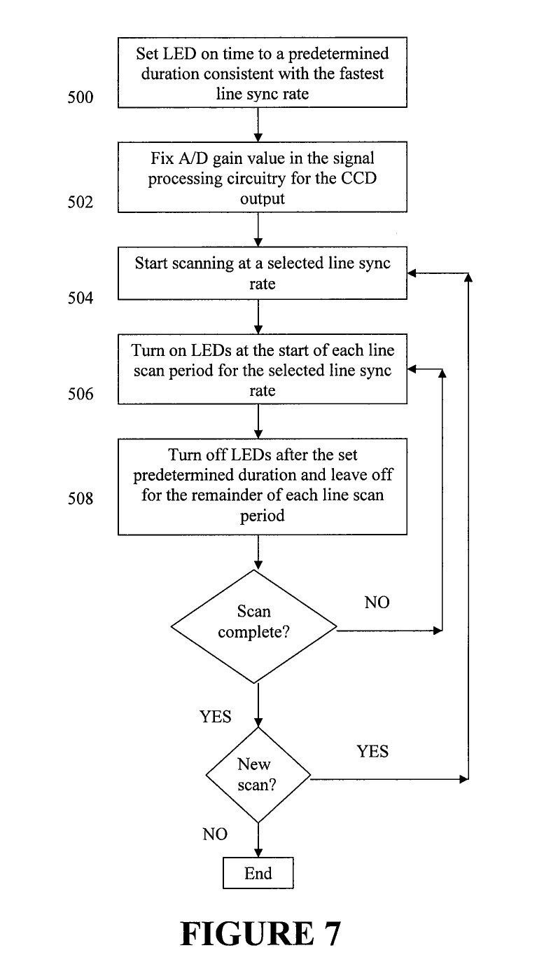

Turning now to FIG. 7, the controlled LED illumination method and system is illustrated in flow chart form. Prior to initial operation of the scanner, the LED on time duration is determined and set or fixed consistent with the fastest line sync rate, step 500. Also prior to initial operation of the scanner, the A/D gain value in the signal processing circuitry for the CCD output is set or fixed, step 502. Preferably, the A/D gain will be set relatively low to produce a good signal to noise ratio in the A/D. The setting of the LED on time and the A/D gain value is also dependent upon the LED intensity of the scanner. In the controlled LED illumination method and system, the LED intensity is fixed, preferably at the high drive current. Thus, the LED drive current will not vary, providing for a fixed LED intensity during the scanning process, regardless of the line sync rate. Setup processes or steps 500 and 502 are only required infrequently since the LED brightness and A/D converter gains vary slowly over time.

Thereafter, in the operation of the scanner, the line sync rate is determined or selected and scanning operation starts, step 504. Although sync rate can be selected, those skilled in the art will recognize that an operator is likely to select scan parameters such as color; black and white; or fragile document. The sync rate is then set based on the operator selections. The operator may make these selections on a scanner control panel or by using an operator interface that is part of a computer system to which the scanner is interfaced. The LED control is automatic based on the operator selections.

After the line sync rate is determined, the LEDs are turned on at the start of the line scan period, step 506, and will remain on for the duration determined in step 500. After the predetermined duration, the LEDs are turned off for the remainder of the line scan period, step 508. Steps 506 and 508 are repeated for each successive line scan period until the scanning operation has been completed. Any time a new scan is desired, the scanning operation will start at step 504, and the on and off times of the LEDs will be controlled accordingly.

While the foregoing discussion presents the teachings in an exemplary fashion with respect to a conventional scanner device, it will be apparent to those skilled in the art that the teachings may apply to any type of device that employs an LED light source for an image capture or sensing device. Additionally, while the foregoing discussion presents the teachings in an exemplary fashion with respect to a CCD sensor, it will be apparent to those skilled in the art that the teachings may apply to any type of sensor used in an image capture or sensing device, such as a CMOS sensor (Complimentary Metal Oxide Semiconductor sensor). Further, while the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

What is claimed is:

1. An illumination system for an imaging device operable at a plurality of line sync rates each defining a line scan period, the system comprising:
an LED light source; and
control circuitry for controlling the on and off times of the LED light source;
wherein the control circuitry turns on the LED light source during the line scan period for a predetermined duration, and turns off the LED light source for a remaining duration of the line scan period.

2. The system of claim 1, wherein the LED light source is a white LED array.

3. The system of claim 2, wherein the LED light source has an intensity which is constant for the plurality of line sync rates.

4. The system of claim 1, wherein the imaging device is used in a scanner, a fax machine, a copy machine, a mail sorting machine, or a mail inserting machine.

5. The system of claim 1, wherein the imaging device has an image sensor providing an output signal, the system further comprising sensor signal processing circuitry applying a set A/D gain value to the output signal of the image sensor.

6. The system of claim 5, wherein the image sensor is a CCD or a CMOS.

7. The system of claim 6, wherein the imaging device is a camera.

8. The system of claim 1, wherein the line sync rate is determined based on operator selected scan parameters, document characteristics, image processing bottlenecks, or computer system bottlenecks.

9. The system of claim 1, wherein the LED light source is turned on at the start of the line scan period.

10. An image scanning device operable at a plurality of line sync rates each defining a line scan period, comprising:
an image sensor for providing an output signal corresponding to a sensed image;
an LED light source for providing illumination for the image sensor;
control circuitry for controlling on and off times of the LED light source; and
sensor signal processing circuitry having a gain amplifier for applying a set gain value to the output signal of the image sensor;
wherein the control circuitry turns on the LED light source for a predetermined duration during each line scan period, and turns off the LED light source for a remainder of each line scan period.

11. The device of claim 10, wherein the LED light source is an LED array.

12. The device of claim 11, wherein the LED light source has an intensity which is constant for the plurality of line sync rates.

13. The device of claim 10, wherein the image sensor is a CCD or a CMOS.

14. The device of claim 10, wherein the line sync rate is determined based on operator selected scan parameters, document characteristics, image processing bottlenecks, or computer system bottlenecks.

15. A method for illumination in an imaging device operable at a plurality of line sync rates each defining a line scan period, the method comprising the step of controlling on and off times of an LED light source proportionally to the line sync rate of the imaging device; wherein the LED light source is turned on for a predetermined duration during each line scan period, and wherein the LED light source is turned off for a remainder of each line scan period.

16. The method of claim 15, wherein the LED light source is an LED array.

17. The method of claim 15, wherein the imaging device is used in a scanner, a fax machine, a copy machine, a mail sorting machine, or a mail inserting machine.

18. The method of claim 15, further comprising the steps of outputting a signal from an image sensor in the imaging device; and applying a set gain value to the output signal independent of the line sync rate.

19. The method of claim 18, wherein the image sensor is a CCD or a CMOS.

20. The method of claim 15, further comprising the step of changing the line sync rate based on operator selected scan parameters, document characteristics, image processing bottlenecks, or computer system bottlenecks, without changing the predetermined on time duration.
